(19) United States
(12) Patent Application Publication
(10) Pub. No.: US 2007/0271107 A1
(43) Pub. Date: Nov. 22, 2007

(54) Context-dependent value help

(75) Inventors: Thomas Fiedler, Pfinztal (DE); Frank Jentsch, Muehlhausen (DE); Friedhelm Krebs, Wiesloch (DE)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(73) Assignee: SAP AG

(21) Appl. No.: 11/436,761

(22) Filed: May 19, 2006

(51) Int. Cl. G06Q 10/00; G06Q 30/00

(52) U.S. Cl. 705/1

(57) ABSTRACT

Methods and apparatus, including computer program products, are provided context-dependent value help information for business objects. In one exemplary embodiment, there is provided a method for providing context-dependent value help information. The method may include receiving a call at a first service provider to instantiate a first business object. The method may also include calling a second service provider when the first service provider determines that a context-dependent value help information is required. Moreover, the method may include receiving a call at the second service provider to instantiate a second business object to provide the determined context-dependent value help information. The method may further include calling, by the second service provider, the first service provider to provide the determined context-dependent value help information. The method may also include receiving, at the first service provider, the determined context-dependent value help information.

### FIELD OF THE INVENTION

The present invention generally relates to data processing. More particularly, the present invention relates to systems and methods for providing context-dependent value help information for business objects.

### BACKGROUND OF THE INVENTION

There is, and will continue to be, advances and changes in how enterprises conduct business. Whether these advances and changes occur through growing competition and globalization, mergers and acquisition, or a revamping of business models, the key for success will often depend on how quickly the enterprise's information technology (IT) organization can adapt to evolving business needs. Therefore, a major challenge to these enterprises is how they handle change.

For organizations to enable business agility, they must ensure that enterprise applications are not only high-performance business engines driving efficiencies, but also that they become flexible building blocks of future business systems. A recent promising solution has risen in the form of services. A service, such as a Web service or other program accessible through a network, represents a self-contained, self-describing piece of application functionality that can be found and accessed by other applications. A service may be considered self-contained because the application using the service does not have to depend on anything other than the service itself, and self-describing because all the information on how to use the service can be obtained from the service itself. The descriptions are centrally stored and accessible through standard mechanisms.

Instead of requiring programmers to establish and maintain links between applications, services are loosely coupled, making connections simpler and more flexible and allowing application architects to more easily find and understand services offered by other cooperative applications. However, the problem that exists with services is that they are often designed to expose functionality of individual applications and thus are too limited to be efficient building blocks for enterprise-wide business processes. A solution to this shortfall has been the migration to a Service Oriented Architecture (SOA). The SOA is an open architecture middleware, which builds on the benefits of services. An example of an SOA can be found in the Enterprise Service Framework (ESF), which is commercially available from SAP AG, Walldorf, Germany. The term “SOA” may also be used to refer to “distributed objects” architecture, such as CORBA (Common Object Request Broker Architecture) and DCOM (Distributed Component Object Model).

The SOA enables the abstraction of business objects (BO), modeled as services (also referred to as enterprise services), from actual applications. Aggregating services into business-level enterprise services may provide more meaningful building blocks for the task of automating enterprise-scale business scenarios. Enterprise services allow IT organizations to efficiently develop composite applications, defined as applications that compose functionality and information from existing systems to support new business processes or scenarios.

The SOA also enables the use of an enterprise services repository. The enterprise services repository stores relevant pre-existing enterprise services and makes them available to selected partners and customers. By using the enterprise services repository, these selected partners and customers can use the pre-existing enterprise services to aid in the implementation of new services and corresponding business objects. The term business object (BO) represents a data structure, such as an object having significance to a business (e.g. a business object for providing a purchase order). An “object” refers to a software bundle of variables (e.g., data) and related methods. For example, in object-oriented programming, an object is a concrete realization (instance) of a class that consists of data and the operations associated with that data.

When services and business objects are developed, the fields which may be filled in with values at the user interface may be defined within the business object and may be fixed for the lifetime of the application providing the business object. For example, a business object for a purchase order may have a field for the purchase order id and a field for the date. If these fields need to be updated or changed, each business object that contains the values must be updated as well. As such, there is a need to improve development of business objects and their corresponding values.

### SUMMARY OF THE INVENTION

The present invention provides methods and apparatus, including computer program products, for generating context-dependent value help information.

In one exemplary embodiment, there is provided a method for providing context-dependent value help information. The method may include receiving a call at a first service provider to instantiate a first business object. The method may also include calling a second service provider when the first service provider determines that a context-dependent value help information is required. Moreover, the method may include receiving a call at the second service provider to instantiate a second business object to determine the context-dependent value help information. The method may further include calling, by the second service provider, the first service provider to provide the determined the context-dependent value help information. The method may also include receiving, at the first service provider, the determined context-dependent value help information.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the present invention and, together with the description, help explain some of the principles associated with the invention. In the drawings,

FIG. 1 illustrates a block diagram of an exemplary system environment consistent with certain aspects related to the present invention;

FIG. 2 illustrates an exemplary schema consistent with certain aspects related to the present invention;

FIG. 3 illustrates a flow chart with exemplary steps for generating objects consistent with certain aspects related to the present invention; and

FIG. 4 illustrates a screenshot of a user interface with a pull down window showing context-dependent value help information consistent with certain embodiments of the present invention.

### DESCRIPTION OF THE EMBODIMENTS

Reference will now be made in detail to the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

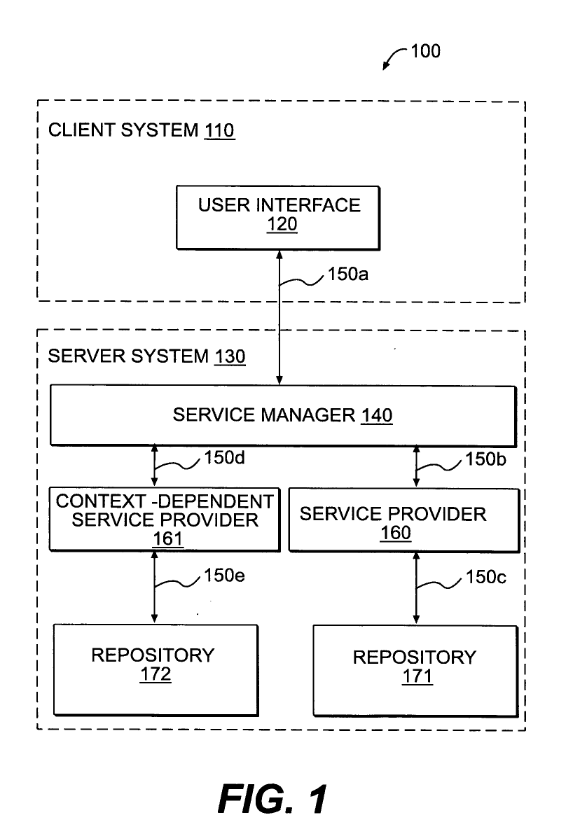

FIG. 1 is a block diagram of an exemplary system 100 environment that includes a client system 110 and a server system 130 for generating business objects. Client system 110 includes a user interface (UI) 120. Client system 110 connects to server system 130 through network connection 150a. Server system 130 further includes service manager (SM) 140, service provider 160, a context-dependent service provider 161, and repositories 171 and 172. System 100 may be implemented as part of an enterprise services framework (ESF). An enterprise services framework is a type of computer framework, such as a client-server architectural framework, that includes one or more services, such as service providers 160 and 161. The services are accessible to other parts of the ESF, such as client systems and their corresponding users, through a communication mechanism such as the Internet or an intranet. The ESF may be constructed using tools provided by SAP Netweaver™ (commercially available from SAP AG, Walldorf, Germany). Although FIG. 1 shows a single client system 110 and a single server system 130, a plurality of client systems and server systems may be used. Moreover, the components depicted in FIG. 1 may be distributed among multiple locations. Although FIG. 1 is described with respect to a client-server architecture and an ESF, system 100 can also use any other architecture or framework.

Client system 110 may include one or more processors, such as computers, to interface with server system 130. User interface 120 may provide an interface to allow a user to interact, through service manager 140, with other applications, such as service providers 160-161 and their corresponding business objects stored in repositories 171-172. Moreover, a service, such as service 160 may call another service, such as context-dependent service provider 161 to obtain context dependent value help. Value help information may be information, such as values, to help a user perform a task (e.g. complete a purchase order). This value help information may be provided based on context, such as the context of information provided by the user or the context of the service. For example, if the user inputs Germany (“GE”) as the destination country for the purchase order, a context-dependent service provider 161 may be called to provide context-dependent value help information. In this example, the context-dependent service provider 161 returns, for the context “GE,” a complete list of the regions (also referred to as provinces) associated with the country code “GE” determined at runtime.

Moreover, another service provider (not shown) may also call context-dependent service provider 161 to obtain context-dependent value help. For example, a service provider may generate shipping documents for a user at user interface 120. In this example, the service provider may receive an input from a user that the destination country for the shipping documents is GE, enabling the service provider to call context-dependent service provider 161 with the context “GE.” The context-dependent service provider 161 responds by calling the shipping documents service provider to provide the value help information (e.g. regions in a Germany), which allows the shipping documents service provider to generate value help information for display at user interface 120. Accordingly, context-dependent service provider 161 provides a service that provides value help information to other services or applications—reducing and/or eliminating the need for each of these other services to include their own dedicated value help information.

A user may be any type of user, such as a system designer, a software developer, and/or a processor. User interface 120 may include a browser to provide content from service providers 160-161. In some implementations, SAP Web Dynpro (commercially available from SAP AG, Walldorf, Germany) is used as a model-based development environment for generating user interface 120, although other development environments can also be used.

Network connections 150a-150e may include, alone or in any suitable combination, a telephony-based network, a local area network (LAN), a wide area network (WAN), a dedicated intranet, wireless LAN, the Internet, an intranet, a wireless network, a bus, or any other communication mechanisms. Further, any suitable combination of wired and/or wireless components and systems may provide network connections 150a-150e. Moreover, network connections 150a-150e may be embodied using bi-directional, unidirectional, or dedicated communication links. Network connections 150a-150e may also implement standard transmission protocols, such as Transmission Control Protocol/Internet Protocol (TCP/IP), Hyper Text Transfer Protocol (HTTP), SOAP, RPC, or other protocols.

Server system 130 may include one or more processors, such as computers, to interface with other computers, such as client system 110. Client system 110 may call service manager 140 at server 130. Although service manager 140, service providers 160-161, and repositories 171-172 are depicted within server 130, they can each be located anywhere and distributed among multiple locations.

Moreover, when service manager 140 is called by user interface 120, service manager 140 may call a procedure to instantiate service provider 160. As used herein, the term “instantiate” means, in an object oriented programming environment, an object of a particular class, and, more generally, includes deploying, customizing, running and/or executing an application. Service provider 160 may be implemented as a service which may be called by service manager 140. An example of a service is a Web service, although any other type of application accessible through a network may be used. When service provider 160 is instantiated by service manager 140, service provider 160 may also instantiate one or more corresponding business objects. For example, a user of user interface 120 may access service provider 160 to interact with a product catalog or sales order. The data and methods associated with providing the product catalog or sales order to user interface 120 correspond to a business object. A business object may also include a business object node, which refers to a portion of the business object. In some instances, a business object may be implemented as a data structure including methods and/or procedures associated with that data. Returning to the above product catalog example, a business object node may refer to another object, such as a price or a product description, included within the business object. Business objects and nodes may be stored in a repository, such as repositories 171 or 172.

Repositories 171-172 may be implemented as a storage device for storing information associated with business objects including their metadata. Repositories 171-172 may store information associated with the business objects (e.g., the data and methods associated with the product catalog or sales order) including metadata for the business objects. For example, repositories 171-172 may store a list of business object nodes including an identifier (ID) and data content. The ID of a business object refers to an identifying memory address of a business object node that uniquely identifies individual business object nodes within repositories 171-172. The memory address can be used to access and read data content of a particular business object node. For example, an ID of a business object node may consist of a directory structure and filename associated with the business object node. Repositories 171-172 may be implemented as an enterprise services repository, although any other computer-readable storage medium may be used.

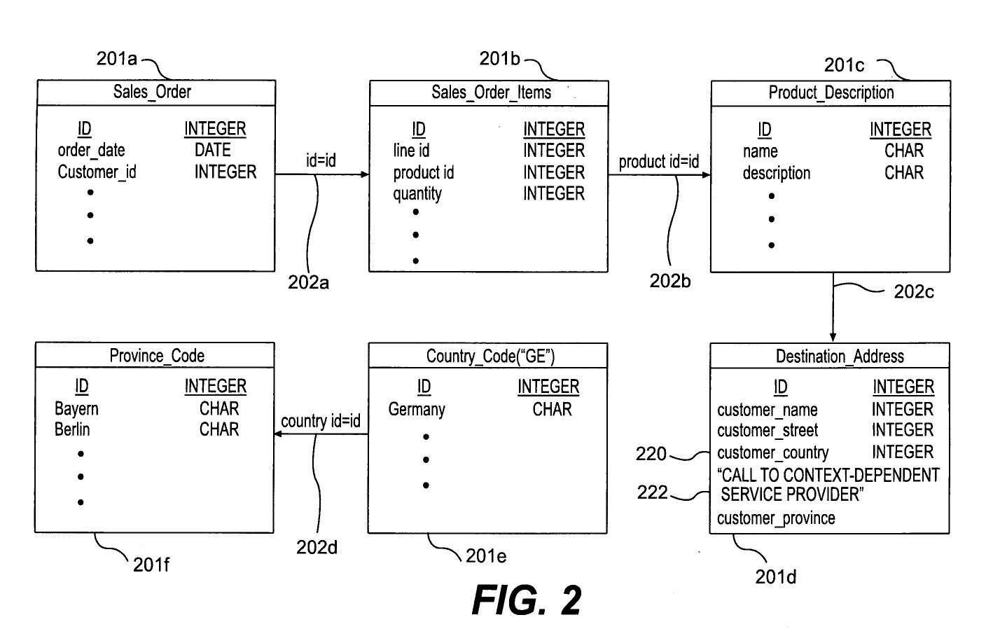

Repositories 171-172 may also store metadata regarding one or more business objects. Metadata may be defined as data about data. For example, metadata may refer to information about the data itself, such as content, quality, condition, origin, size, formatting, characteristics of data, and the like. The eXtensible Markup Language (XML) is a specific example of metadata because it is a format used to define other data objects. Metadata may include a schema. A schema is the organization or structure, such as the organization of a database or the structure of an object in an object oriented program. In object oriented programming, modeling (i.e., the analysis of objects that are used in a business or other context and the identification of the relationships among these data objects) leads to a schema, which can be stored in repositories 171-172 as a schema. The schema can be depicted visually as a structure or a formal text-oriented description (e.g., script). For example, metadata may be in the form of database tables. The metadata may include information such as the number of nodes in a business object, the name(s) of the nodes, the position of a node in the business object hierarchy, the structure of a node, associations, actions, and default queries on a node. An exemplary XML data schema is further described below in relation to FIG. 2.

FIG. 2 depicts an example schema for business object nodes containing data stored at repository 171 and 172. During design time, the business objects are designed (or modeled), and at runtime the business objects are instantiated so that a user may interact (e.g. view, fill-ins, store, and the like) with an “instance” of the business object. The schema includes a business object node for a sales order 201a, the sales order items 201b included with sales order 201a, the corresponding product description 201c, and the destination address 201d for the products. Moreover, the schema depicted in FIG. 2 may include keys 201a-201c that identify the relationships among the business object nodes 201a-201d. For example, key 202a is a sales order identification value (“id”) that is used to link business object nodes 201a and 201b. Key 202b links the product identification values (“product id”) of sales order items 201b to the product description values of product description 201c. Key 202c links the product description values of the sale order to the destination address 201d.

The schema, which depicts business object nodes and how they are associated to one another, may be considered metadata and stored in a repository, such as repository 171. Moreover, the schema may be considered a “model” of how to implement these business object nodes. The model may serve as a template to enable the composition of other models for business objects and their nodes. The models may also be used to generate script for generating code for the business objects and their nodes. The schema may be stored as metadata in repository 171. During the final implementation of system 100, a user would interact (e.g. view, fill-ins, store, and the like) with a service provider to access the business objects (e.g. business objects for a purchase order) stored at the repository 171.

At runtime, the destination address business object node 201d may prompt the user to provide an address. Runtime refers to any time other than when business objects in repositories 171 and 172 are being designed. One of the fields for the destination address that the user may enter is the country code (e.g. GE, USA, GB, etc.). Destination address node 201d depicts the field for the country code as “customer_country” 220. Based on the country code that the user inputs, the destination address business object 201d may determine that context-dependent value help information should be determined by making a call to context-dependent service provider 222. Value help information may be information, such as values, to help a user perform a task (e.g. complete a purchase order). This value help information may be provided based on the context of the information from the user. For example, if the user inputs Germany (“GE”) as the destination country for the purchase order, context-dependent value help information may provide provinces associated with the context of country code (e.g. Germany or GE) determined at runtime. Once the destination address business object node 201d determines that a call to the context-dependent service provider 161 is required, the destination address business object node 198d may call the context-dependent service provider 161 by, for example, sending a Simple Object Access Protocol (SOAP) message or making a Remote Procedure Call to context-dependent service provider 161.

Once the destination address business object node 201d calls the context-dependent service provider 161, the context-dependent service provider 161 receives the call. The call to context-dependent service provider 161 may include information identifying the context of the call. In this case, the call would include runtime information, such as country code GE. Once the call is received, the context-dependent service provider 161 may instantiate one or more corresponding business object nodes that may be stored in repository 172.

FIG. 2 further depicts business object node 201e for the context of country code and business object node 201f for the region or province code corresponding to the country code that was provided by service 160. These business object nodes are stored in repository 172. Key 202d is a region or province code identification value (“country id”) that is used to link the country code 201e and regions or provinces 201f. For example, if the user inputs Germany (“GE”) as the destination country in the business object node 201d for the destination address, the user may also need to select the corresponding region or province in Germany. However, business object node 201d may not have information associated with the provinces in Germany, and may not be able to provide a list of provinces to the user. Therefore, business object node 201d may need value help information that is dependent on the context of the country (e.g. Germany). If value help information is needed, destination address business object node 201d calls the context-dependent service provider 161, and the context-dependent service provider 161 may receive the call, including information identifying the context of the call (e.g. a country code “GE”). Context-dependent service provider 161 may instantiate the business object node for the country code 201e for Germany (“GE”). Once this business object is instantiated, the business object may generate a list that may include only the provinces that correspond to the country Germany (“GE”).

Once the context-dependent service provider 161 determines the list of province codes associated with the context, in this case the country code GE (i.e. Germany), the service provider 160 may receive the context-dependent value help information from the context-dependent service provider 161. Once the service provider 160 receives this context-dependent value help information, the service provider 160 may instantiate any additional business objects to incorporate the received context-dependent value help information.

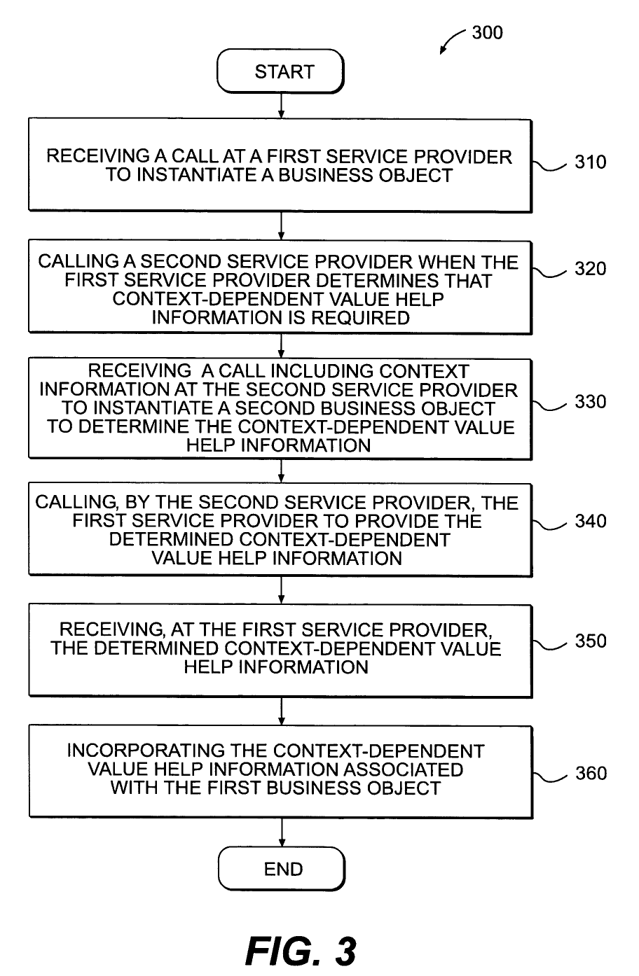

FIG. 3 is a flowchart of exemplary steps for generating context-dependent value help information. At runtime, the first service provider 160 receives a call, such as a SOAP message, Remote Procedure Call (RPC), or any other type of call, from the service manager 140 to instantiate a business object at step 310. The service provider 160 may instantiate one or more business objects in repository 171. For example, the one or more business objects may include a sales order 201a, sales order items 201b, product descriptions 201c, and the user destination address 201d. During runtime, the user may select the items and complete a sales order by entering a destination address. When the user enters the destination country, destination address business object 198d may determine that context-dependent value help information is required. For example, when a user inputs “GE,” value help in the form of a list of provinces may be required. The value help information is dependent on the context, which in this example is “GE.” If context-dependent value help information is required, the destination address business object 198d may call the context-dependent service provider 161 at step 320. The call may provide the “context.” For example, when a user enters Germany (“GE”) as the desired country in the business object node for the destination address 201d, the destination address business object node 201d may call the context-dependent service provider 161 which provides a list of the corresponding provinces based on the context.

Once the call is received at context-dependent service provider 161, context-dependent service provider 161 may instantiate the business object nodes for the country code 201e for Germany and corresponding regions or province codes 201f (e.g. Baden-Württemberg, Bayern, Berlin, Brandenburg, Bremen, Hamburg, Hessen, Mecklenburg-Vorpommern, Niedersachsen, Nordrhein-Westfalen, Rheinland-Pfalz, Saarland, Sachsen, Sachsen-Anhalt, Schleswig-Holstein, and Thüringen) at step 330. Once the province list is generated by business object node 201f, context-dependent service provider 161 may call service provider 160 to provide the context-dependent information, such as the list of provinces that correspond to the country code Germany at step 340. This call may include the original context, such as “GE,” and the corresponding provinces. The service provider 160 may receive the call from the context-dependent service provider 161 at step 350. Finally, the service provider 160 may incorporate the list of provinces associated the country code Germany at step 360. Once this list is incorporated, the user may be presented with a list of the provinces corresponding to Germany, and the user may select the desired province as part of the destination address.

In this example, the list of provinces depend on the country code that may be entered by the user. Based on the “context” of the country code (e.g. “Germany”), the service provider 160 may receive the call from the context-dependent service provider 161 that includes the list of provinces that correspond to the country code Germany. The above example of context-dependent service provider 161 providing context-dependent value help is only exemplary since service provider 161 may provide any other context-dependent value help information. For example, based on the context of “destination address,” context-dependent service provider 161 may provide a sales order item that contains only the products that can be shipped to that destination address. For example, if the context of “destination address” is only accessible by air, then flammable materials may not be listed in the value help provided by context-dependent service provider 161 to service provider 160 for a sales order. Also, there may be a set quantity of each product that the user may purchase based on the destination address. Context-dependent value help information may thus be used to determine the type of product that may be ordered and the quantity of each product. Moreover, although the context may based on information provided by a user at runtime, any other context may be used. For example, the state or status of the service 160 may be used to determine the context for which value help information should be determined.

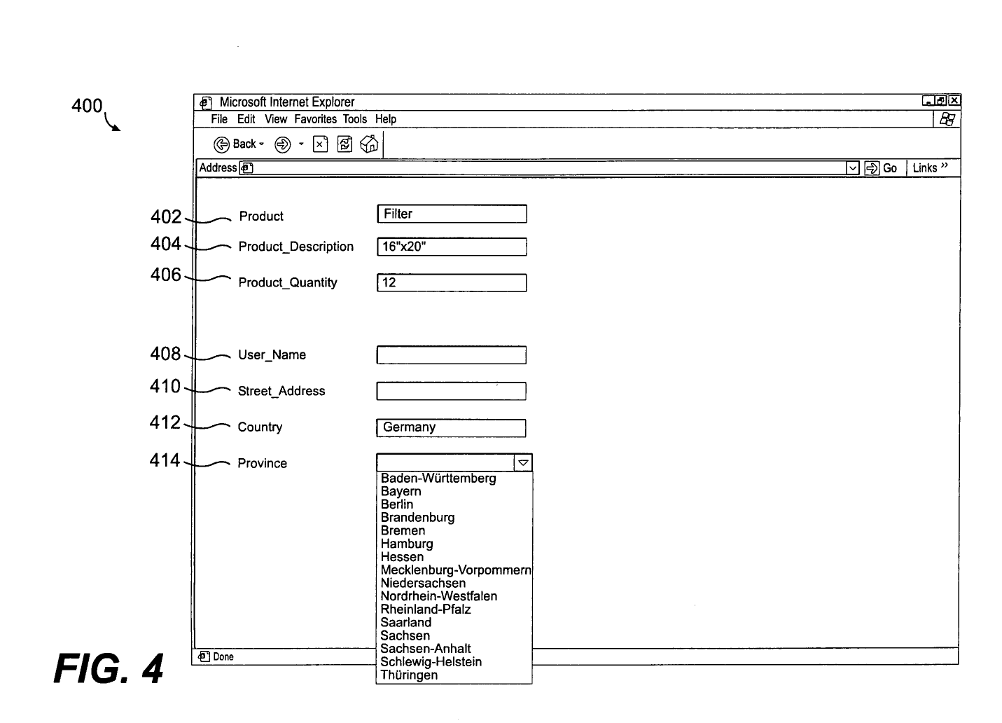

FIG. 4 depicts a user interface 400 where a sales order form can be viewed, and modified using a user interface, such as a Java Applet window, although other graphical user interfaces may be used as well.

At runtime, user interface 120 calls service manager 140. Service manager 140 may call a procedure to instantiate service provider 160. When service provider 160 is instantiated, service provider 160 may also instantiate one more business objects for a sales order. The business objects, which include business object nodes, may be stored in repository 171. For example, business object nodes may exist for a sales order 201a, the sales order items 201b included with sales order 201a, and the corresponding product description 201c. The user may then select one or more products 402 as sales order items. The business object node 201c for the corresponding product description may display the product description 404, and the user may select a desired quantity 406 of the product. The destination address business object node 201d may display entry fields for the user to enter a user name 408, a destination street address 410, and a destination country 412. FIG. 4 depicts a product 402 of filter, a product description 404 of 16″×20″, and a product quantity of 12. FIG. 4 also depicts the user providing a destination country 412 of Germany.

When the user enters the destination country 412, destination address business object 201d may determine that context-dependent value help information should be determined. Once the destination address business object node 201d determines that a call to the context-dependent service provider 161 is required (See, e.g., FIG. 2 at 222), the destination address business object node 198d may call the context-dependent service provider 161. Once the call is received, the context-dependent service provider 161 may instantiate one or more corresponding business object nodes that may be stored in repository 172, such as business object node 201e for the country code and business object node 201f for the province code corresponding to the country code that was input. The call to context-dependent service provider 161 may include information identifying the context of the call (e.g. country code is “GE”). Context-dependent service provider 161 may instantiate the business object node for the country code 201e for Germany (“GE”). Once this business object is instantiated, the business object may generate a list that may include only the provinces that correspond to the country Germany (“GE”).

Once the context-dependent service provider 161 determines the list of province codes associated with the context, in this case the country code GE (i.e. Germany), the service provider 160 may receive the context-dependent value help information from the context-dependent service provider 161. When the service provider 160 receives this context-dependent value help information, the service provider 160 may instantiate any additional business objects to incorporate the received context-dependent value help information. Once the additional business objects are instantiated, a list of provinces in Germany 414 may be provided to user interface 120 for display so that the user may select the appropriate province for the destination address. FIG. 4 also depicts the provided value help province information 414.

The foregoing description is intended to illustrate but not to limit the scope of the invention, which is defined by the scope of the appended claims. Other embodiments are within the scope of the following claims.

What is claimed is:

1. A computer-readable medium containing instructions to configure a processor to perform a method for providing context-dependent value help information for business objects, the method comprising:
receiving a call at a first service provider to instantiate a first business object;
calling a second service provider when the first service provider determines that a context-dependent value help information is required;
receiving a call at the second service provider to instantiate a second business object to determine the context-dependent value help information;
calling, by the second service provider, the first service provider to provide the determined context-dependent value help information; and
receiving, at the first service provider, the determined context-dependent value help information.

2. The computer-readable medium of claim 1, wherein receiving the call at the first service provider further comprises:
implementing the first service provider as a web service capable of receiving the call.

3. The computer-readable medium of claim 1, wherein calling the second service provider further comprises:
determining the context-dependent value help information based on an input from a user interface.

4. The computer-readable medium of claim 1, wherein receiving the call at the second service provider further comprises:
receiving a context from the first service provider.

5. The computer-readable medium of claim 4, further comprising:
using the received context to determine the context-dependent value help information by retrieving the context-dependent value help information from a data structure.

6. The computer-readable medium of claim 1, further comprising:
instantiating at least one of the first and second business objects as a data structure.

7. A system for providing context-dependent value help information for business objects, the system comprising:
a processor; and
a memory, wherein the processor and the memory are configured to perform a method comprising:
receiving a call at a first service provider to instantiate a first business object;
calling a second service provider when the first service provider determines that a context-dependent value help information is required;
receiving a call at the second service provider to instantiate a second business object to determine the context-dependent value help information;
calling, by the second service provider, the first service provider to provide the determined context-dependent value help information; and
receiving, at the first service provider, the determined context-dependent value help information.

8. The system of claim 7, wherein receiving the call at the first service provider further comprises:
implementing the first service provider as a web service capable of receiving the call.

9. The system of claim 7, wherein calling the second service provider further comprises:
determining the context-dependent value help information based on an input from a user interface.

10. The system of claim 7, wherein receiving the call at the second service provider further comprises:
receiving a context from the first service provider.

11. The system of claim 10, further comprising:
using the received context to determine the context-dependent value help information by retrieving the context-dependent value help information from a data structure.

12. The system of claim 7, further comprising:
instantiating at least one of the first and second business objects as a data structure.

13. A method for providing context-dependent value help information for business objects, the method comprising:
receiving a call at a first service provider to instantiate a first business object;
calling a second service provider when the first service provider determines that a context-dependent value help information is required;
receiving a call at the second service provider to instantiate a second business object to determine the context-dependent value help information;
calling, by the second service provider, the first service provider to provide the determined context-dependent value help information; and
receiving, at the first service provider, the determined context-dependent value help information.

14. The method of claim 13, wherein receiving the call at the first service provider further comprises:
implementing the first service provider as a web service capable of receiving the call.

15. The method of claim 13, wherein calling the second service provider further comprises:
determining the context-dependent value help information based on an input from a user interface.

16. The method of claim 13, wherein receiving the call at the second service provider further comprises:
receiving a context from the first service provider.

17. The method of claim 16, further comprising:
using the received context to determine the context-dependent value help information by retrieving the context-dependent value help information from a data structure.

18. The method of claim 13, further comprising:
instantiating at least one of the first and second business objects as a data structure.
